(19) United States
(12) Patent Application Publication
(10) Pub. No.: US 2023/0083104 A1
(43) Pub. Date: Mar. 16, 2023

(54) Efficiently Deleting Snapshots in a Log-Structured File System (LFS)-Based Storage System

(71) Applicant: VMware, Inc., Palo Alto, CA (US)

(72) Inventors: Enning Xiang, San Jose, CA (US); Pranay Singh, San Ramon, CA (US); Wenguang Wang, Santa Clara, CA (US)

(21) Appl. No.: 17/471,568

(22) Filed: Sep. 10, 2021

(51) Int. Cl. G06F 16/11; G06F 3/06

(52) U.S. Cl. CPC G06F 16/128; G06F 3/0604; G06F 3/0631; G06F 3/0673

(57) ABSTRACT

At the time of deleting a snapshot, a storage system can allocate a buffer in volatile memory, scan a plurality of logical block address (LBA)-to-virtual block address (VBA) mappings included in a first tree metadata structure of the snapshot, and, for each scanned LBA-to-VBA mapping, identify in a second tree metadata structure a VBA-to-physical block address (PBA) mapping referenced by the LBA-to-VBA mapping. If the VBA-to-PBA mapping is exclusively owned by the snapshot, the storage system can add a record to the buffer that includes the VBA specified in the VBA-to-PBA mapping. The storage system can subsequently sort the records added to the buffer in VBA order and sequentially process the sorted records to remove their corresponding VBA-to-PBA mappings from the second tree metadata structure.

### BACKGROUND

A log-structured file system (LFS) is a type of file system that writes data to nonvolatile storage (i.e., disk) sequentially in the form of an append-only log rather than performing in-place overwrites. This improves write performance by allowing small write requests to be batched into large sequential writes but requires a segment cleaner that periodically identifies under-utilized segments on disk (i.e., segments with a large percentage of “dead” data blocks that have been superseded by newer versions) and reclaims the under-utilized segments by compacting their remaining live data blocks into other, empty segments.

Snapshotting is a storage feature that allows for the creation of snapshots, which are point-in-time read-only copies of storage objects such as files. Snapshots are commonly used for data backup, archival, and protection (e.g., crash recovery) purposes. Copy-on-write (COW) snapshotting is an efficient snapshotting implementation that generally involves (1) maintaining, for each storage object, a B+ tree (referred to as a “logical map”) that keeps track of the storage object’s state in the form of [logical block address (LBA) → (physical block address (PBA)] key-value pairs (i.e., LBA-to-PBA mappings), and (2) at the time of taking a snapshot of a storage object, making the storage object’s logical map immutable/read-only, designating this immutable logical map as the logical map of the snapshot, and creating a new logical map for the current (i.e., live) version of the storage object that includes a single root node pointing to the first level tree nodes of the snapshot’s logical map (which allows the two logical maps to share the same LBA-to-PBA mappings).

If a write is subsequently made to the storage object that results in a change to a particular LBA-to-PBA mapping, a copy of the leaf node in the snapshot’s logical map that holds the affected mapping—as well as copies of any internal tree nodes between the leaf node and the root node—are created, and the storage object’s logical map is updated to point to the newly-created node copies, thereby diverging it from the snapshot’s logical map along that particular tree branch. The foregoing steps are then repeated as needed for further snapshots of, and modifications to, the storage object.

One challenge with implementing COW snapshotting in an LFS-based storage system is that the LFS segment cleaner may occasionally need to relocate on disk the logical data blocks of one or more snapshots in order to reclaim under-utilized segments. This is problematic because snapshot logical maps are immutable once created; accordingly, the LFS segment cleaner cannot directly change the LBA-to-PBA mappings of the affected snapshots to reflect the new storage locations of their logical data blocks.

It is possible to overcome this issue by replacing the logical map of a storage object and its snapshots with two separate B+ trees: a first B+ tree, also referred to as a “logical map,” that includes [LBA → (virtual block address (VBA)] key-value pairs (i.e., LBA-to-VBA mappings), and a second B+ tree, referred to as an “intermediate map,” that includes [VBA —> PBA] key-value pairs (i.e., VBA-to-PBA mappings). In this context, a VBA is a monotonically increasing number that is incremented each time a new PBA is allocated and written for a given storage object, such as at the time of processing a write request directed to that object. With this approach, the LFS segment cleaner can change the PBA to which a particular LBA is mapped by modifying the VBA-to-PBA mapping in the intermediate map without touching the corresponding LBA-to-VBA mapping in the logical map, thereby enabling it to successfully update the logical to physical mappings of COW snapshots.

However, the use of an intermediate map raises its own set of complications for snapshot deletion, which requires, among other things, (1) identifying VBA-to-PBA mappings in the intermediate map that are exclusively owned by the snapshot to be deleted (and thus are no longer needed once the snapshot is gone), and (2) removing the exclusively owned mappings from the intermediate map. A straightforward way to implement (2) is to remove each exclusively owned VBA-to-PBA mapping individually as it is identified. Unfortunately, because the removal operation involves reading and writing an entire leaf node of the intermediate map (which will typically be many times larger than a single VBA-to-PBA mapping), the input/output (I/O) cost for removing each VBA-to-PBA mapping using this technique will be significantly amplified. For snapshots that have a large number of exclusively owned VBA-to-PBA mappings, such as old snapshots whose data contents have been mostly superseded by newer snapshots, this will result in high I/O overhead and poor system performance at the time of snapshot deletion.

### BRIEF DESCRIPTION OF THE DRAWINGS

FIG. 1 depicts an example LFS-based storage system according to certain embodiments.

FIGS. 2A, 2B, 2C, and 2D illustrate the effects of COW snapshotting on the logical map of an example storage object.

FIGS. 3A and 3B depict the implementation of a two-level logical to physical mapping mechanism with an intermediate map for the example storage object of FIGS. 2A-2D.

FIG. 4 depicts a workflow for removing, from an intermediate map, VBA-to-PBA mappings exclusively owned by a snapshot according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Certain embodiments of the present disclosure are directed to techniques for efficiently deleting a snapshot of a storage object in an LFS-based storage system. These techniques assume that the storage system maintains a logical map for the snapshot comprising LBA-to-VBA mappings, where each LBA-to-VBA mapping specifies an association between a logical data block of the snapshot and a unique, monotonically increasing virtual block address. The techniques further assume that the storage system maintains an intermediate map for the storage object and its snapshots comprising VBA-to-PBA mappings, where each VBA-to-PBA mapping specifies an association between a virtual block address and a physical block (or sector) address. Taken together, the logical map and the intermediate map enable the storage system to keep track of where the snapshot’s logical data blocks reside on disk.

In one set of embodiments, at the time of deleting the snapshot, the storage system can scan through the snapshot’s logical map, identify VBA-to-PBA mappings in the intermediate map that are “exclusively owned” by the snapshot (i.e., are referenced solely by that snapshot’s logical map), and append records identifying the exclusively owned VBA-to-PBA mappings to a volatile memory buffer. These exclusively owned VBA-to-PBA mappings are mappings that should be removed from the intermediate map as part of the snapshot deletion process because they are not referenced by any other logical map and thus are no longer needed once the snapshot is deleted. Each record appended to the memory buffer can include, among other things, the VBA specified in its corresponding VBA-to-PBA mapping.

The storage system can then sort the records in the memory buffer according to their respective VBAs and process the sorted records in a batch-based manner (e.g., in accordance with intermediate map leaf node boundaries), thereby enabling the storage system to remove the exclusively owned VBA-to-PBA mappings from the intermediate map using a minimal number of I/O operations. For example, assume the memory buffer includes the following five records, sorted in ascending VBA order: [VBA2], [VBA3], [VBA6], [VBA100], [VBA110]. Further assume that records [VBA2], [VBA3], and [VBA6] correspond to VBA-to-PBA mappings M1, M2, and M3 residing on a first leaf node N1 of the intermediate map and records [VBA100] and [VBA110] correspond to VBA-to-PBA mappings M4 and M5 residing on a second leaf node N2 of the intermediate map. In this scenario, the storage system can process [VBA2], [VBA3], and [VBA6] together as a batch, which means that the storage system can read leaf node N1 from disk into memory, modify N1 to remove mappings M1, M2, and M3, and subsequently flush (i.e., write) the modified version of N1 to disk. Similarly, the storage system can process [VBA100] and [VBA110] together as a batch, which means that the storage system can read leaf node N2 from disk into memory, modify N2 to remove mappings M4 and M5, and subsequently flush the modified version of N2 to disk.

With this approach, the I/O cost of removing VBA-to-PBA mappings that are part of the same intermediate map leaf node is amortized across those mappings, resulting in reduced I/O overhead for snapshot deletion and thus improved system performance. The foregoing and other aspects of the present disclosure are described in further detail below.

### 2. Example LFS-Based Storage System

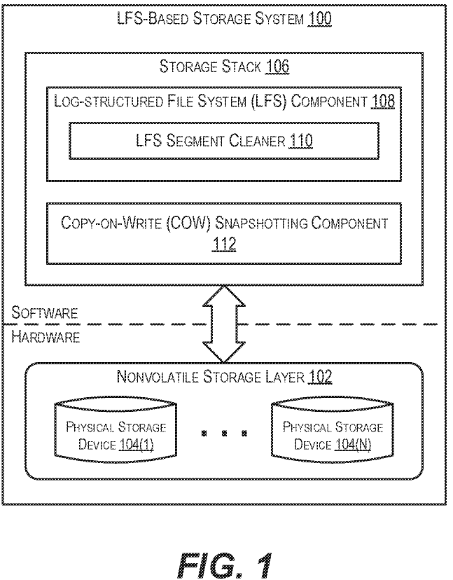

FIG. 1 is a simplified block diagram of an LFS-based storage system 100 in which embodiments of the present disclosure may be implemented. As shown, storage system 100 includes, in hardware, a nonvolatile storage layer 102 comprising a number of physical storage devices 104(1)-(N) (e.g., magnetic disks, solid state disks (SSDs), non-volatile memory (NVM) modules, etc.). Storage system 100 also includes, in software, a storage stack 106 comprising a log-structured file system (LFS) component 108 (with an LFS segment cleaner 110) and a copy-on-write (COW) snapshotting component 112.

LFS component 108 is configured to manage the storage of data in nonvolatile storage layer 102 and write data modifications to layer 102 in a sequential, append-only log format. This means that logical data blocks are not overwritten in place on disk; instead, each time a write request is received for a logical data block, a new physical data block is allocated on nonvolatile storage layer 102 and written with the latest version of the logical data block’s content. By avoiding in-place overwrites, LFS component 108 can advantageously accumulate multiple small write requests directed to different LBAs of a storage object in an in-memory buffer and, once the buffer is full, write out all of the accumulated write data (collectively referred to as a “segment”) via a single, sequential write operation. This is particularly useful in scenarios where storage system 100 implements RAID-⅚ erasure coding across nonvolatile storage layer 102 because it enables the writing of data as full RAID-⅚ stripes and thus eliminates the performance penalty of partial stripe writes.

To ensure that nonvolatile storage layer 102 has sufficient free space for writing new segments, LFS segment cleaner 110 periodically identifies existing segments on disk that have become under-utilized due to the creation of new, superseding versions of the logical data blocks in those segments. The superseded data blocks are referred to as dead data blocks. LFS segment cleaner 110 then reclaims the under-utilized segments by copying their remaining non-dead (i.e., live) data blocks in a compacted form into one or more empty segments, which allows the under-utilized segments to be deleted and reused.

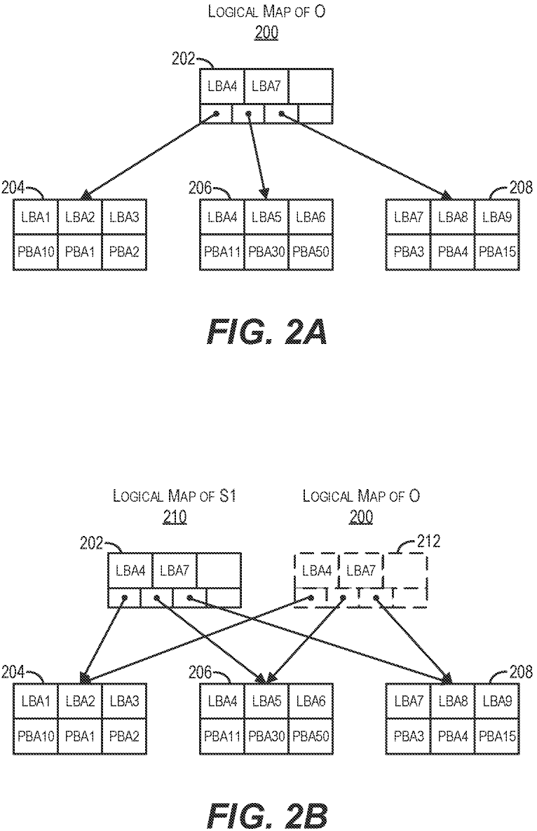

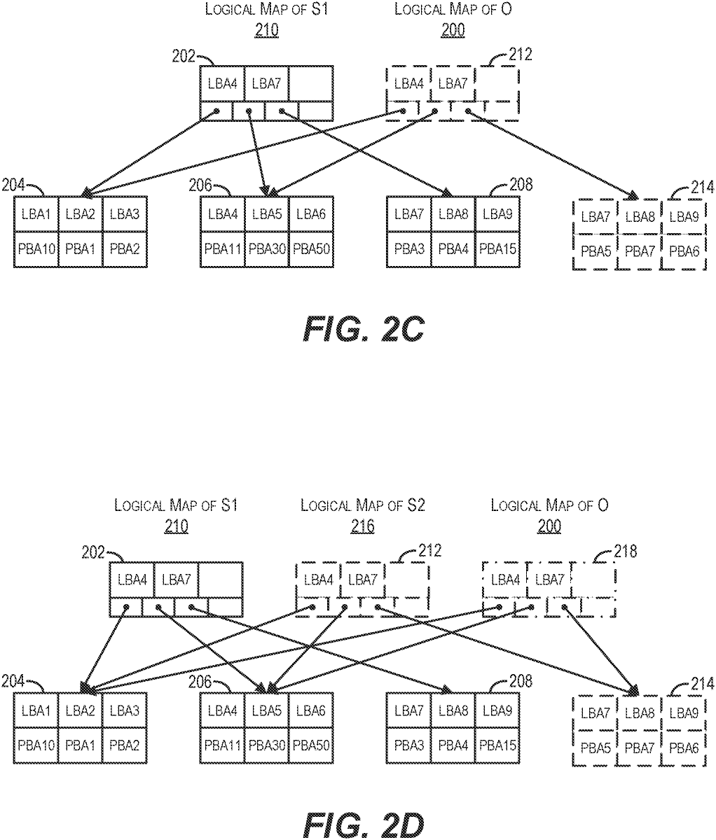

COW snapshotting component 112 of storage stack 106 is configured to create snapshots of the storage objects maintained in storage system 100 by manipulating, via a copy-on-write mechanism, B+ trees (i.e., logical maps) that keep track of the storage objects’ states. To explain the general operation of COW snapshotting component 112, FIGS. 2A, 2B, 2C, and 2D depict the logical map of an example storage object O and how this logical map changes (and how snapshot logical maps are created) as O is modified and snapshotted. These figures assume that the schema of the logical map for storage object O is [Key: LBA —> Value: PBA], which records the logical to physical mapping of a single data block per key-value pair. In alternative embodiments the schema can also include a “number of blocks” parameter in the value field, thereby allowing each key-value pair to capture the logical to physical mapping of an “extent” comprising one or more contiguous data blocks (as specified via the number of blocks parameter).

FIGS. 2A, 2B, 2C, and 2D further assume, for purposes of illustration, that the maximum number of key-value pairs (i.e., mappings) that can be held at each logical map leaf node is three. In practice, each leaf node may hold significantly more key-value pairs (e.g., on the order of hundreds or thousands).

Starting with FIG. 2A, this figure depicts an initial state of a logical map 200 of storage object O that comprises a root node 202 with keys LBA4 and LBA7 and pointers to three leaf nodes 204, 206, and 208. Leaf node 204 includes LBA-to-PBA mappings for LBA1-LBA3 of O (i.e., [LBA1 ⇢ PBA10], [LBA2 → PBA1], and [LBA3 → PBA2]), leaf node 206 includes LBA-to-PBA mappings for LBA4-LBA6 of O (i.e., [LBA4 → PBA11], [LBA5 → PBA30], and [LBA6 → PBA50]), and leaf node 208 includes LBA-to-PBA mappings for LBA7-LBA9 of O (i.e., [LBA7 → PBA3], [LBA8 → PBA4], and [LBA9 → PBA15]).

FIG. 2B depicts the outcome of taking a snapshot S1 of storage object O at the point in time shown in FIG. 2A. Per FIG. 2B, tree nodes 202-208—which were previously part of logical map 200 of storage object O—are now designated as being part of a logical map of snapshot S1 (reference numeral 210) and made immutable/read-only. In addition, a new root node 212 is created that includes the same keys and pointers as root node 202 and is designated as the root node of logical map 200 of storage object O. This enables the logical map of the current (i.e., live) version of storage object O to share the same leaf nodes (and thus same LBA-to-PBA mappings) as the logical map of snapshot S1, because they are currently identical. Node 212, which is “owned” by (i.e., part of the logical map of) live storage object O, is illustrated with dashed lines to differentiate it from nodes 202-208, which are now owned by snapshot S1.

FIG. 2C depicts the outcome of receiving, after the creation of snapshot S1, writes to storage object O that result in the following new LBA-to-PBA mappings: [LBA7 —> PBA5], [LBA8 → PBA7], and [LBA9 → PBA6]. As shown in FIG. 2C, a copy 214 of leaf node 208 is created (because leaf node 208 contains prior mappings for LBA7-LBA9) and this copy is updated to include the new mappings noted above. In addition, root node 212 of logical map 200 of storage object O is modified to point to copy 214 rather than to original node 208, thereby updating O's logical map to include this new information.

Finally, FIG. 2D depicts the outcome of taking another snapshot S2 of storage object O at the point in time shown in FIG. 2C. Per FIG. 2D, tree nodes 212 and 214—which were previously part of logical map 200 of storage object O—are now designated as being part of a logical map of snapshot S2 (reference numeral 216) and made immutable/read-only. In addition, a new root node 218 is created that includes the same keys and pointers as root node 212 and is designated as the root node of logical map 200 of storage object O. Node 218, which is owned by live storage object O, is illustrated with alternating dashed and dotted lines to differentiate it from nodes 212 and 214, which are now owned by snapshot S2. The general sequence of events shown in FIGS. 2A-2D can be repeated as further snapshots of, and modifications to, storage object O are taken/received, resulting in a continually expanding set of interconnected logical maps for O and its snapshots that capture the incremental changes made to O during each snapshot interval.

As noted in the Background section, LFS segment cleaner 110 may occasionally need to move the logical data blocks of one or more snapshots across nonvolatile storage layer 102 as part of its segment cleaning duties. For example, if logical data blocks LBA1-LBA3 of snapshot S1 shown in FIGS. 2B-2D reside in a segment SEG1 that is under-utilized, LFS segment cleaner 110 may attempt to move these logical data blocks to another, empty segment so that SEG1 can be reclaimed. However, because the logical maps of COW snapshots are immutable once created, LFS segment cleaner 110 cannot directly modify the mappings in snapshot S1’s logical map to carry out this segment reclamation operation.

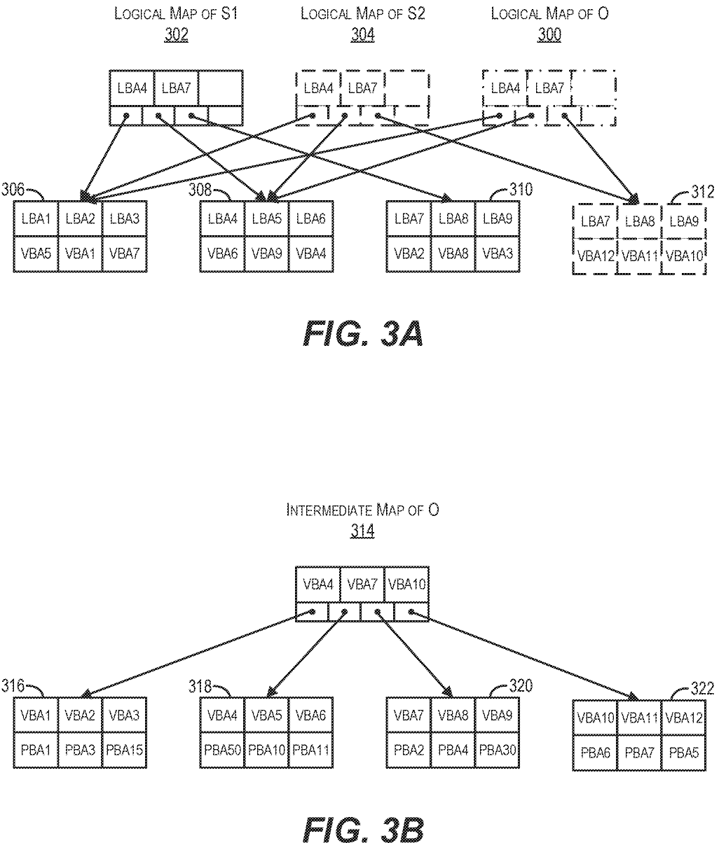

One solution for this issue is to implement a two-level logical to physical mapping mechanism that comprises a per-object/snapshot logical map with a schema of [Key: LBA → Value: VBA] and a per-object intermediate map with a schema of [Key: VBA —> Value: PBA]. The VBA element is a monotonically increasing number that is incremented as new PBAs are allocated and written for the storage object. This solution introduces a layer of indirection between logical and physical addresses and thus allows LFS segment cleaner 110 to change a PBA by modifying its VBA-to-PBA mapping in the intermediate map, without modifying the corresponding LBA-to-VBA mapping in the logical map. By way of example, FIG. 3A depicts alternative versions of the logical maps for storage object O and snapshots S1 and S2 from FIG. 2D (i.e., reference numerals 300, 302, and 304) that incorporate LBA-to-VBA mappings at leaf nodes 306, 308, 310, and 312, and FIG. 3B depicts an intermediate map 314 for storage object O that incorporates VBA-to-PBA mappings at leaf nodes 316, 318, 320, and 322 corresponding to the LBA-to-VBA mappings of logical maps 300, 302, and 304.

However, a complication with this two-level logical to physical mapping mechanism is that it can cause performance problems when deleting snapshots. For example, consider a scenario in which snapshot S1 of storage object O is marked for deletion at the point in time shown in FIGS. 3A and 3B. In this scenario, as part of the deletion of snapshot S1, storage system 100 should remove VBA-to-PBA mappings [VBA2 —> PBA3], [VBA8 —> PBA4], and [VBA3 —> PBA15] from intermediate map 314 because these mappings are solely referenced by S1’s logical map 302—or in other words, are exclusively owned by S1—and thus are no longer needed once S1 is deleted. This exclusive ownership can be observed in FIG. 3A, where logical map 302 of S1 is the only logical map pointing to the leaf node (i.e., 310) that includes LBA-to-VBA mappings referencing VBA2, VBA8, and VBA3.

One approach for carrying out the mapping removal process is to scan the logical map of snapshot S1, check, for each encountered LBA-to-VBA mapping, whether the corresponding VBA-to-PBA mapping in intermediate map 314 is exclusively owned by S1, and if the answer is yes, remove that VBA-to-PBA mapping from intermediate map 314 by reading, from disk, the intermediate map leaf node where the mapping is located, modifying the leaf node to delete the mapping, and writing the modified leaf node back to disk. However, this approach requires the execution of three separate leaf node reads/writes in order to remove exclusively owned mappings [VBA2 → PBA3], [VBA8 → PBA4], and [VBA3 → PBA15] from intermediate map 314, even though [VBA2 → PBA3] and [VBA3 → PBA15] reside on the same intermediate map leaf node 316: a first read and write of leaf node 316 to remove [VBA2 —> PBA3], a second read and write of leaf node 320 to remove [VBA8 —> PBA4], and a third read and write of leaf node 316 to remove [VBA3 —> PBA15]. This is problematic because (1) the size of an intermediate map leaf node will typically be many times larger than the size of a single VBA-to-PBA mapping (e.g., 4 kilobytes (KB) vs. 32 bytes), resulting in a significant I/O amplification effect for each mapping removal, and (2) in practice the snapshot to be deleted may have hundreds or thousands of exclusively owned VBA-to-PBA mappings, resulting in very high overall I/O cost, and thus poor system performance, for the snapshot deletion task.

### 3. Solution Description

To address the foregoing and other similar problems, in certain embodiments storage system 100 of FIG. 1 can implement an efficient approach for removing exclusively owned VBA-to-PBA mappings from an intermediate map such as map 314 of FIG. 3B. At a high level this approach comprises, at the time of deleting a snapshot, (1) allocating/initializing a buffer in volatile memory, (2) traversing the snapshot’s logical map, (3) for each LBA-to-VBA mapping encountered during the traversal, determining whether its corresponding VBA-to-PBA mapping in the intermediate map is exclusively owned by the snapshot, and (4) if the answer at (3) is yes, adding a record of the VBA-to-PBA mapping (including at least the VBA specified in the mapping) to the memory buffer.

Once the memory buffer is full (or there are no additional records to add), the approach further comprises (5) sorting the records in the memory buffer in VBA order, and (6) sequentially processing the sorted records in a batch-based manner to remove the records’ corresponding VBA-to-PBA mappings from the intermediate map. In various embodiments, the batch-based processing at step (6) involves removing VBA-to-PBA mappings that belong to the same intermediate leaf node from the intermediate map as a single group. Finally, steps (1)-(6) are repeated as needed until the entirety of the snapshot’s logical map has been traversed and processed.

By sorting the memory buffer records by VBA at step (5), storage system 100 can ensure that exclusively owned VBA-to-PBA mappings residing on the same intermediate map leaf node appear contiguously in the memory buffer (because the intermediate map is keyed and ordered by VBA). This, in turn, allows storage system 100 to easily process the records in batches at step (6) according to leaf node boundaries (rather than processing each record individually), leading to a reduced average I/O cost per record/mapping and thus improved system performance. For example, if this efficient approach is applied to remove the exclusively owned VBA-to-PBA mappings of snapshot S1 from intermediate map 314 of FIG. 3B, the following will occur:
a) The memory buffer will be populated with records [VBA2], [VBA8]. [VBA3]
b) The memory buffer will be re-sorted to contain [VBA2], [VBA3]. [VBA8]
c) The storage system will determine that contiguous records [VBA2] and [VBA3] correspond to VBA-to-PBA mappings [VBA2 → PBA3] and [VBA3 → PBA15] that reside on the same leaf node 316, read leaf node 316 from disk into memory, modify leaf node 316 to remove [VBA2 → PBA3] and [VBA3 → PBA15], and write the modified leaf node back to disk
d) The storage system will determine that record [VBA8] corresponds to VBA-to-PBA mapping [VBA8 → PBA4] on leaf node 320, read leaf node 320 from disk into memory, modify leaf node 320 to remove [VBA8 → PBA4], and write the modified leaf node back to disk

As can be seen above, the storage system will only need to perform a single leaf node read and write at (b) in order to remove VBA-to-PBA mappings [VBA2 → PBA3] and [VBA3 → PBA15] from intermediate map 314 because they are part of the same leaf node 316. Accordingly, the I/O cost and amplification effect of the leaf node read/write is advantageously amortized across these two mappings. In some embodiments, the I/O costs needed to access/modify index (i.e., non-leaf) nodes in the intermediate map in response to leaf nodes changes may also be amortized in a similar manner, resulting in even further I/O overhead savings.

It should be appreciated that FIGS. 1, 2A-D, and 3A-B are illustrative and not intended to limit embodiments of the present disclosure. For example, although storage system 100 of FIG. 1 is depicted as a singular entity, in certain embodiments storage system 100 may be distributed in nature and thus consist of multiple networked storage nodes, each holding a portion of the system’s nonvolatile storage layer 102. Further, although FIG. 1 depicts a particular arrangement of components within storage system 100, other arrangements are possible (e.g., the functionality attributed to a particular component may be split into multiple components, components may be combined, etc.). One of ordinary skill in the art will recognize other variations, modifications, and alternatives.

### 4. Mapping Removal Workflow

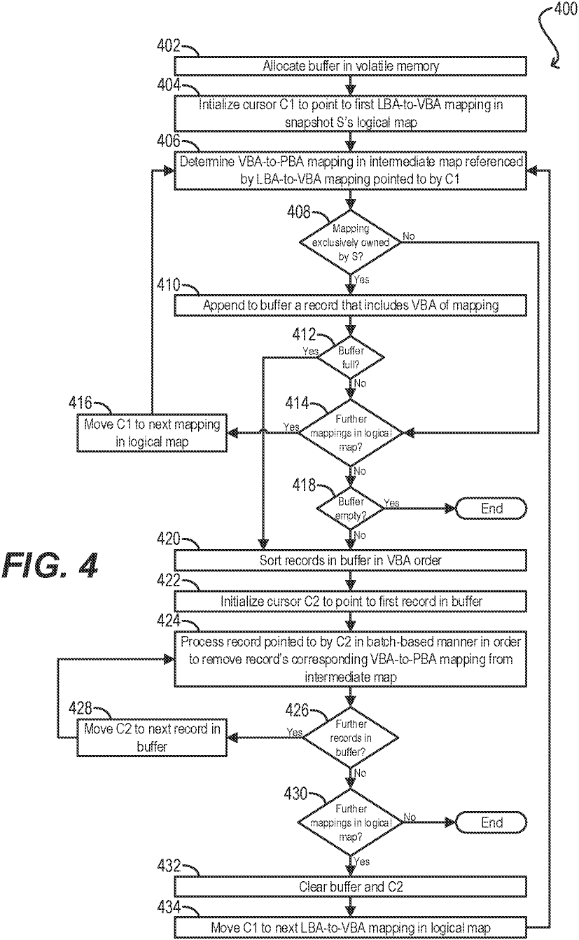

FIG. 4 depicts a workflow 400 that can be executed by storage system 100 of FIG. 1 at the time of deleting a snapshot S of a storage object O for removing the exclusively owned VBA-to-PBA mappings of S from O’s intermediate map according to certain embodiments.

Starting with step 402, storage system 100 can allocate a buffer in volatile memory for temporarily holding information (i.e., records) regarding the VBA-to-PBA mappings exclusively owned by snapshot S. As mentioned previously, a VBA-to-PBA mapping is deemed to be “exclusively owned” by a given snapshot if the logical map of that snapshot is the only logical map in the storage system which references (i.e., includes an LBA-to-VBA mapping pointing to) the VBA-to-PBA mapping. In one set of embodiments, the memory buffer allocated at step 402 can be sized based on a combination of various factors such as the write workload of snapshot S, the storage system block size, the fan-out of the intermediate map, the average load rate at each intermediate map leaf node, and the estimated percentage of VBA-to-PBA mappings exclusively owned by S.

At step 404, storage system 100 can initialize a first cursor C1 to point to the first LBA-to-VBA mapping in snapshot S’s logical map (e.g., the mapping with the lowest LBA). Storage system 100 can then determine the VBA-to-PBA mapping in the intermediate map referenced by the LBA-to-VBA mapping pointed to by cursor C1 (step 406) and check whether this VBA-to-PBA mapping is exclusively owned by snapshot S (step 408). In one set of embodiments, storage system 100 can perform this check by searching for the same VBA-to-PBA mapping in the logical map of a child (i.e., later) snapshot of storage object O. If the same VBA-to-PBA mapping is not found in a child snapshot logical map, storage system 100 can conclude that the mapping is exclusively owned by snapshot S.

If the answer at step 408 is no, storage system 100 can proceed to step 414 described below. However, if the answer at step 408 is yes, storage system 110 can append a record to the memory buffer that includes the VBA specified in the VBA-to-PBA mapping (step 410). In certain embodiments this record can also include other information extracted from the mapping, such as the “number of blocks” parameter in scenarios where the mapping identifies an extent (rather than a single data block).

Upon appending the record, storage system 100 can check whether the memory buffer is now full (step 412). If so, storage system 100 can proceed to step 420 described below. However, if the answer at step 412 is no, storage system 100 can check whether there are any further LBA-to-VBA mappings in snapshot S’s logical map (step 414).

If the answer at step 414 is yes, storage system 100 can move cursor C1 to the next mapping in the logical map (416) and return to block 406. Otherwise, storage system 100 can proceed to check whether the memory buffer is empty (step 418).

If the answer at step 418 is yes, storage system 100 can conclude that there is no further work to be done and can terminate the workflow. Otherwise, storage system 100 can sort the records in the memory buffer in VBA order (step 420). In certain embodiments, as part of this step, storage system 100 can determine the range of VBAs that were created during the lifetime of snapshot S and can use a sorting algorithm that is optimized for sorting elements within a known range (e.g., counting sort).

Storage system 100 can then initialize a second cursor C2 to point to the first record in the memory buffer (step 422) and can process the record pointed to by C2 in order to remove the record’s corresponding VBA-to-PBA mapping from the intermediate map (step 424). As mentioned previously, this processing can be performed in a batch-based manner in accordance with the leaf node boundaries in the intermediate map. For example, as part of the processing at step 424, storage system 100 can determine whether the record’s VBA-to-PBA mapping resides on the same intermediate map leaf node as the record processed immediately prior to this one. If the answer is yes, the contents of that leaf node will be in memory per the processing performed for the prior record. Accordingly, storage system can update the in-memory copy of the leaf node to remove the record’s VBA-to-PBA mapping.

However, if the answer is no (i.e., the record’s VBA-to-PBA mapping resides on a different leaf node), storage system 100 can flush the leaf node that it has in memory (if any) to disk, retrieve the leaf node of the current record/mapping from disk, and remove the mapping from the in-memory version of the leaf node. This modified leaf node will be subsequently flushed if the next record processed by the storage system resides on a different intermediate leaf node (thus indicating the start of a new batch).

Upon processing the record, storage system 100 can check whether there are any further records in the memory buffer (step 426). If the answer is yes, storage system 100 can move cursor C2 to the next record in the memory buffer (step 428) and return to step 424 in order to process it.

If the answer at step 426 is no, storage system 100 check whether there are any further LBA-to-VBA mappings in snapshot S’s logical map (step 430). If there are, storage system 100 can clear the memory buffer and cursor C2 (step 432), move cursor C1 to the next LBA-to-VBA mapping in the logical map (step 434), and return to step 406.

Finally, if there are no further LBA-to-VBA mappings in snapshot S’s logical map, the workflow can end.

### 5. Crash Resiliency

To provide resiliency/robustness against system crashes, in certain embodiments workflow 400 of FIG. 4 can be modified to save cursors C1 and C2 to nonvolatile storage on a periodic basis. For example, storage system 100 can save these cursors each time a predefined number of records in the memory buffer have been successfully processed.

With this enhancement, if storage system 100 crashes in the middle of executing workflow 400, the system can resume the workflow from the recovery point recorded in the saved cursors (e.g., LBA-to-VBA mapping X and record Y), thereby avoiding the need to restart the entire process.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations and equivalents can be employed without departing from the scope hereof as defined by the claims.

What is claimed is:

1. A method comprising, at a time of deleting a snapshot of a storage object maintained on a storage system:
allocating, by the storage system, a buffer in volatile memory;
scanning, by the storage system, a plurality of logical block address (LBA)-to-virtual block address (VBA) mappings included in a first tree metadata structure associated with the snapshot; and
for each LBA-to-VBA mapping in the plurality of LBA-to-VBA mappings:
identifying, in a second tree metadata structure associated with the storage object, a VBA-to-physical block address (PBA) mapping that is referenced by the LBA-to-VBA mapping; and
upon determining that the VBA-to-PBA mapping is exclusively owned by the snapshot, adding, to the buffer, a record that includes a VBA specified in the VBA-to-PBA mapping.

2. The method of claim 1 further comprising:
sorting the records added to the buffer in VBA order; and
sequentially processing the sorted records to remove their corresponding VBA-to-PBA mappings from the second tree metadata structure.

3. The method of claim 2 wherein the sequentially processing comprises, for each subset of the sorted records residing on a leaf node of the second tree metadata structure:
reading the leaf node from disk into volatile memory;
modifying the leaf node to remove one or more VBA-to-PBA mappings corresponding to the subset; and
writing the modified leaf node back to disk.

4. The method of claim 1 wherein the LBA-to-VBA mapping specifies an association between a logical data block of the snapshot and a unique, monotonically increasing number that is selected at a time a new physical data block is allocated for the logical data block.

5. The method of claim 4 wherein the VBA-to-PBA mapping referenced by the LBA-to-VBA mapping identifies an association between the unique, monotonically increasing number and a physical location of the logical data block on disk.

6. The method of claim 1 wherein determining that the VBA-to-PBA mapping is exclusively owned by the snapshot comprises:
determining that the VBA-to-PBA mapping is not referenced by any other instance of the first tree metadata structure owned by the storage object or a different snapshot of the storage obj ect.

7. The method of claim 2 further comprising:
maintaining a first cursor pointing to an LBA-to-VBA mapping in the plurality of LBA-to-VBA mappings that is currently being scanned;
maintaining a second cursor pointing to a record in the buffer that is currently being processed; and
periodically saving the first and second cursors to disk.

8. A non-transitory computer readable storage medium having stored thereon program code executable by a storage system, the program code embodying a method comprising, at a time of deleting a snapshot of a storage object maintained on the storage system:
allocating a buffer in volatile memory;
scanning a plurality of logical block address (LBA)-to-virtual block address (VBA) mappings included in a first tree metadata structure associated with the snapshot; and
for each LBA-to-VBA mapping in the plurality of LBA-to-VBA mappings:
identifying, in a second tree metadata structure associated with the storage object, a VBA-to-physical block address (PBA) mapping that is referenced by the LBA-to-VBA mapping; and
upon determining that the VBA-to-PBA mapping is exclusively owned by the snapshot, adding, to the buffer, a record that includes a VBA specified in the VBA-to-PBA mapping.

9. The non-transitory computer readable storage medium of claim 8 wherein the method further comprises:
sorting the records added to the buffer in VBA order; and
sequentially processing the sorted records to remove their corresponding VBA-to-PBA mappings from the second tree metadata structure.

10. The non-transitory computer readable storage medium of claim 9 wherein the sequentially processing comprises, for each subset of the sorted records residing on a leaf node of the second tree metadata structure:
reading the leaf node from disk into volatile memory;
modifying the leaf node to remove one or more VBA-to-PBA mappings corresponding to the subset; and
writing the modified leaf node back to disk.

11. The non-transitory computer readable storage medium of claim 8 wherein the LBA-to-VBA mapping specifies an association between a logical data block of the snapshot and a unique, monotonically increasing number that is selected at a time a new physical data block is allocated for the logical data block.

12. The non-transitory computer readable storage medium of claim 11 wherein the VBA-to-PBA mapping referenced by the LBA-to-VBA mapping identifies an association between the unique, monotonically increasing number and a physical location of the logical data block on disk.

13. The non-transitory computer readable storage medium of claim 8 wherein determining that the VBA-to-PBA mapping is exclusively owned by the snapshot comprises:
determining that the VBA-to-PBA mapping is not referenced by any other instance of the first tree metadata structure owned by the storage object or a different snapshot of the storage obj ect.

14. The non-transitory computer readable storage medium of claim 9 wherein the method further comprises:
maintaining a first cursor pointing to an LBA-to-VBA mapping in the plurality of LBA-to-VBA mappings that is currently being scanned;
maintaining a second cursor pointing to a record in the buffer that is currently being processed; and
periodically saving the first and second cursors to disk.

15. A storage system comprising:
a processor; and
a non-transitory computer readable medium having stored thereon program code that, when executed, causes the processor to, at a time of deleting a snapshot of a storage object maintained on the storage system:
allocate a buffer in volatile memory;
scan a plurality of logical block address (LBA)-to-virtual block address (VBA) mappings included in a first tree metadata structure associated with the snapshot; and
for each LBA-to-VBA mapping in the plurality of LBA-to-VBA mappings:
identify, in a second tree metadata structure associated with the storage object, a VBA-to-physical block address (PBA) mapping that is referenced by the LBA-to-VBA mapping; and
upon determining that the VBA-to-PBA mapping is exclusively owned by the snapshot, add, to the buffer, a record that includes a VBA specified in the VBA-to-PBA mapping.

16. The storage system of claim 15 wherein the program code further causes the processor to:
sort the records added to the buffer in VBA order; and
sequentially process the sorted records to remove their corresponding VBA-to-PBA mappings from the second tree metadata structure.

17. The storage system of claim 16 wherein the program code that cause the processor to sequentially process the sorted records comprises program code that causes the processor to, for each subset of the sorted records residing on a leaf node of the second tree metadata structure:
read the leaf node from disk into volatile memory;
modify the leaf node to remove one or more VBA-to-PBA mappings corresponding to the subset; and
write the modified leaf node back to disk.

18. The storage system of claim 15 wherein the LBA-to-VBA mapping specifies an association between a logical data block of the snapshot and a unique, monotonically increasing number that is selected at a time a new physical data block is allocated for the logical data block.

19. The storage system of claim 18 wherein the VBA-to-PBA mapping referenced by the LBA-to-VBA mapping identifies an association between the unique, monotonically increasing number and a physical location of the logical data block on disk.

20. The storage system of claim 15 wherein the program code that causes the processor to determine that the VBA-to-PBA mapping is exclusively owned by the snapshot comprises program code that causes the processor to:
determine that the VBA-to-PBA mapping is not referenced by any other instance of the first tree metadata structure owned by the storage object or a different snapshot of the storage obj ect.

21. The storage system of claim 16 wherein the program code further causes the processor to:
maintain a first cursor pointing to an LBA-to-VBA mapping in the plurality of LBA-to-VBA mappings that is currently being scanned;
maintain a second cursor pointing to a record in the buffer that is currently being processed; and
periodically save the first and second cursors to disk.
